(19) United States
(12) Patent Application Publication
(10) Pub. No.: US 2022/0326994 A1
(43) Pub. Date: Oct. 13, 2022

(54) COMPUTING RESOURCE SHARING SYSTEM

(71) Applicant: Dell Products L.P., Round Rock, TX (US)

(72) Inventor: Julius Mueller, Santa Clara, CA (US)

(21) Appl. No.: 17/227,838

(22) Filed: Apr. 12, 2021

(51) Int. Cl. G06F 9/50; G06F 21/54

(52) U.S. Cl. CPC G06F 9/505; G06F 9/5083; G06F 9/5011; G06F 21/54

(57) ABSTRACT

A computing resource sharing system includes a computing resource sharing controller system coupled to a computing resource provider system and a computing resource consumer system via a network. The computing resource sharing controller system receives an identification of computing resource(s) included in the computing resource provider system for sharing, and computing resource sharing criteria defining how the computing resource(s) may be shared, from the computing resource provider system. The computing resource sharing controller system then subsequently receives a workload request associated with a workload from the computing resource consumer system. Based on the computing resource sharing criteria, the computing resource sharing controller system then determines that the workload associated with the workload request may be provided by the computing resource(s) and, in response, provides the workload via the network to the computing resource provider system to cause the computing resource(s) to perform the workload.

### BACKGROUND

The present disclosure relates generally to information handling systems, and more particularly to facilitating the sharing of computing resources included in information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices, desktop computing devices, laptop/notebook computing devices, tablet devices, mobile phones, and/or other computing devices known in the art, often sit unutilized during their lifecycle. For example, server devices in a datacenter, desktop and laptop/notebook computing devices in a corporate setting, as well as a variety of other computing devices in a variety of other settings, are often heavily utilized during “peak hours” (e.g., during the daytime on weekdays), while being unutilized during “off hours” (e.g., during the nighttime on weekdays and throughout the weekend). This lack of computing device utilization may be viewed as a waste of those computing resources and the funds expended to support them (e.g., funds associated with providing a location where those computing resources are located, powering those computing resources that are not powered down after use, cooling those computing resources that are not powered down after use, funds for maintenance and upgrades of computing resources that are not powered down after use, funds for software and hardware licenses, etc.). As such, computing resources provided in a datacenter, corporate settings, and/or other settings introduce costs associated with their underutilization.

Accordingly, it would be desirable to provide a computing resource sharing system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a computing resource sharing controller engine that is configured to: receive, from a computing resource provider system via the network, an identification of at least one computing resource included in the computing resource provider system for sharing, and computing resource sharing criteria defining how the at least one computing resource may be shared; receive, from a computing resource consumer system via the network and subsequent to receiving the identification of the at least one computing resource and the computing resource sharing criteria, a workload request associated with a workload; determine, based on the computing resource sharing criteria, that the workload associated with the workload request may be provided by the at least one computing resource; and provide, in response to determining that the workload may be provided by the at least one computing resource, the workload via the network to the computing resource provider system to cause the at least one computing resource to perform the workload.

### BRIEF DESCRIPTION OF THE DRAWINGS

FIG. 1 is a schematic view illustrating an embodiment of an Information Handling System (IHS).

FIG. 2A is a schematic view illustrating an embodiment of a networked system that may provide the computing resource sharing system of the present disclosure.

FIG. 2B is a schematic view illustrating an embodiment of communication connections between the systems and devices in the networked systems of FIG. 2A.

FIG. 3 is a schematic view illustrating an embodiment of a computing resource provider system that may be provided in the networked system of FIGS. 2A and 2B.

FIG. 4 is a schematic view illustrating an embodiment of a regional controller subsystem that may be provided in the networked system of FIGS. 2A and 2B.

FIG. 5 is a schematic view illustrating an embodiment of a global controller subsystem that may be provided in the networked system of FIGS. 2A and 2B.

FIG. 6 is a flow chart illustrating an embodiment of a method for sharing computing resources.

FIG. 7 is a swim-lane diagram illustrating an embodiment of communications in the networked system of FIGS. 2A and 2B during the method of FIG. 6.

FIG. 8 is a swim-lane diagram illustrating an embodiment of communications in the networked system of FIGS. 2A and 2B during the method of FIG. 6.

FIG. 9 is a swim-lane diagram illustrating an embodiment of communications in the networked system of FIGS. 2A and 2B during the method of FIG. 6.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network switch device, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

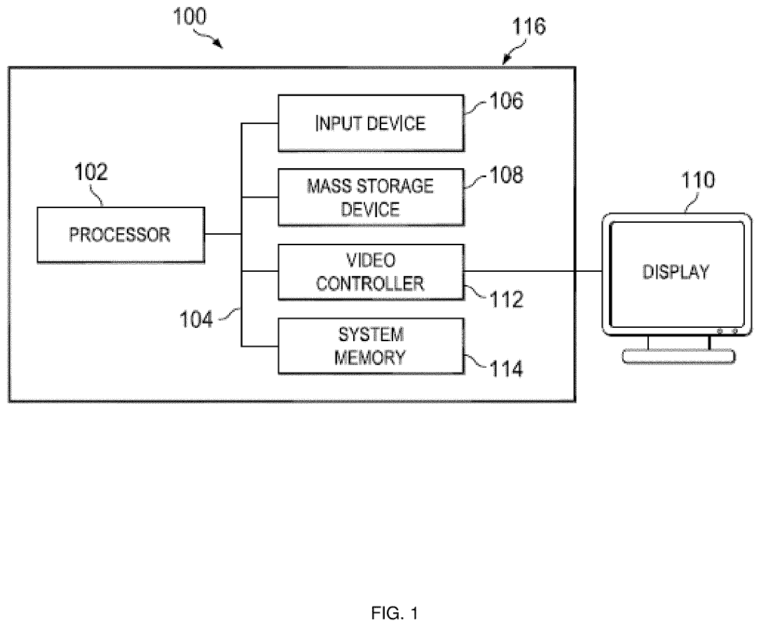

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

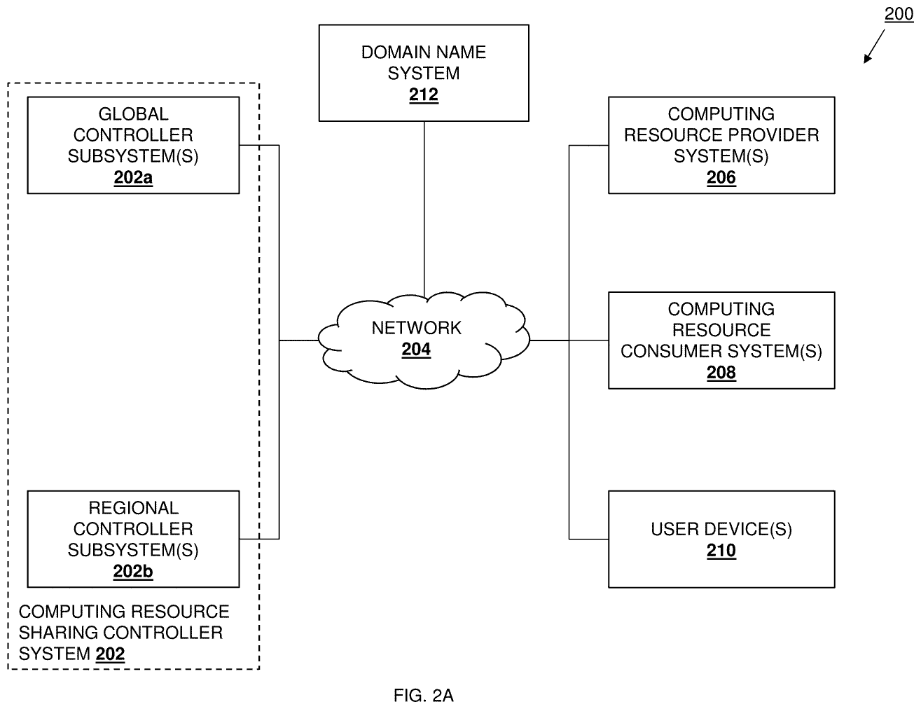

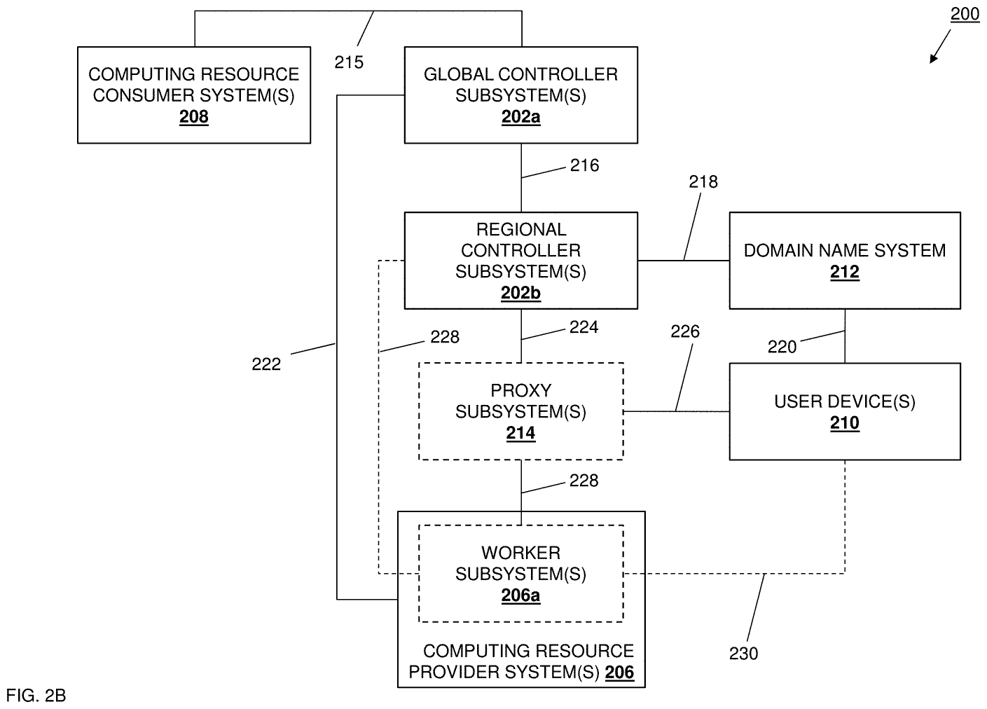

Referring now to FIG. 2A, an embodiment of a networked system 200 is illustrated. In the illustrated embodiment, the networked system 200 includes a computing resource sharing controller system 202 that, in the embodiments illustrated below, is provided by one or more global controller subsystems 202a and one or more regional controller subsystems 202b. In an embodiment, the computing resource sharing controller system 202 may be provided by the IHS 100 discussed above with reference to FIG. 1, and/or may include some or all of the components of the IHS 100, and in a specific example may be provided by one or more server devices. As will be appreciated by one of skill in the art in possession of the present disclosure, the computing resource sharing controller system 202 may be provided by one or more server devices that are co-located or that are in different locations. For example, the global controller subsystem(s) 202a and the regional controller subsystem(s) 202b may be provided by one or more server devices in the same location (e.g., a datacenter), or the global controller subsystem(s) 202a may be provided by one or more server devices in a first location (e.g., a computing resource provider headquarters location) while the regional controller subsystem(s) 202b is provided by one or more server devices in corresponding second location(s) (e.g., in region(s) “controlled” by those regional controller subsystem(s) 202b, discussed in further detail below). However, while illustrated and discussed as being provided by server device(s) in particular location(s), one of skill in the art in possession of the present disclosure will recognize that the computing resource sharing controller system 202 provided in the networked system 200 may include any devices in any locations that may be configured to operate similarly as the computing resource sharing controller system 202 discussed below.

In the illustrated embodiment, the global controller subsystem(s) 202a and regional controller subsystem(s) 202b in the computing resource sharing controller system 202 are coupled to a network 204 that may be provided by a Local Area Network (LAN), the Internet, combinations thereof, and/or any other network that would be apparent to one of skill in the art in possession of the present disclosure. In the illustrated embodiment, one or more computing resource provider systems 206 are also coupled to the network 204. In an embodiment, any or all of the computing resource provider system(s) 206 may include one or more of the IHSs 100 discussed above with reference to FIG. 1, and in the specific examples discussed below are described as including server devices, but that may also (or instead) include desktop computing devices, laptop/notebook computing devices, tablet devices, mobile phones, and/or any other computing devices that one of skill in the art in possession of the present disclosure would recognize as allowing the computing resource sharing operations discussed below. In the illustrated embodiment, one or more computing resource consumer systems 208 are also coupled to the network 204. In an embodiment, any or all of the computing resource consumer system(s) 208 may be provided by the IHS 100 discussed above with reference to FIG. 1, and/or may include some or all of the components of the IHS 100, and in a specific example may be provided by server device(s), desktop computing device(s), laptop/notebook computing device(s), tablet device(s), mobile phone(s), and/or any other computing device(s) that one of skill in the art in possession of the present disclosure would recognize as allowing the computing resource consuming operations discussed below.

In the illustrated embodiment, one or more user devices 210 are also coupled to the network 204. In an embodiment, any or all of the user device(s) 210 may be provided by the IHS 100 discussed above with reference to FIG. 1, and/or may include some or all of the components of the IHS 100, and in a specific example may be provided by desktop computing device(s), laptop/notebook computing device(s), tablet device(s), mobile phone(s), and/or any other computing device(s) that one of skill in the art in possession of the present disclosure would recognize as allowing the user operations discussed below that include accessing resources provided via the performance of workloads in the computing resource sharing system of the present disclosure. In the illustrated embodiment, a domain name system 212 is also coupled to the network 204. In an embodiment, the domain name system 212 may be provided by the IHS 100 discussed above with reference to FIG. 1, and/or may include some or all of the components of the IHS 100, and in a specific example may be provided by one or more server devices that are configured to store and provide routes to access workloads performed in the computing resource sharing system of the present disclosure. However, while a specific networked system 200 has been illustrated and described, one of skill in the art in possession of the present disclosure will recognize that the computing resource sharing system of the present disclosure may include a variety of components and component configurations while remaining within the scope of the present disclosure as well.

With reference to FIG. 2B, an embodiment of the communication connections between the systems, subsystems, and devices in the networked system 200 are illustrated. In the illustrated embodiment, communication connection(s) 215 (e.g., secure communication connection(s) such as Transport Layer Security (TLS) connection(s)) may be provided via the network 204 between each computing resource consumer system 208 and each global controller subsystem 202a, communication connection(s) 216 (e.g., secure communication connection(s) such as TLS connection(s)) may be provided via the network 204 (or directly) between each global controller subsystem 202a and each regional controller subsystem 202b, communication connection(s) 218 may be provided via the network 204 between each regional controller subsystem 202b and the domain name system 212, and communication connection(s) 220 may be provided via the network 204 between each user device 210 and the domain name system 212.

Furthermore, in the specific examples discussed below, the computing resource provider system(s) 206 may be utilized to provide one or more worker subsystem(s) 206a that may generally operate to provide the compute operations that perform the workloads discussed below, while the computing resource provider system(s) 206, regional controller subsystem(s) 202b, and/or the global controller subsystem(s) 202a may be utilized to provide proxy subsystem(s) 214 that may generally operate to provide the workload communication transmission operations between the worker subsystem(s) 206a and the user device(s) 210. As illustrated in FIG. 2B, communication connection(s) 222 (e.g., secure communication connection(s) such as TLS connection(s)) may be provided via the network 204 between each global controller subsystem 202a and each computing resource provider system 206, communication connection(s) 224 (e.g., secure communication connection(s) such as TLS connection(s)) may be provided via the network 204 between each regional controller subsystem 202b and each proxy subsystem 214, communication connection(s) 226 (e.g., secure communication connection(s) such as TLS connection(s)) may be provided via the network 204 between each user device 210 and each proxy subsystem 214, and communication connection(s) 228 (e.g., secure communication connection(s) such as Virtual Private Network (VPN) connection(s)) may be provided via the network 204 (or directly) between each proxy subsystem 214 and each worker subsystem 206a.

As will be appreciated by one of skill in the art in possession of the present disclosure, the proxy subsystem(s) 214 may be utilized to enhance security and privacy in the computing resource sharing system of the present disclosure by providing a proxy layer that, for example, enables the performance of traffic indirection operations, topology hiding operations, TLS and VPN termination operations, traffic redirection operations, and/or other security/privacy operations known in the art. However, in some examples the proxy subsystem(s) 214 may be omitted or otherwise not utilized, and instead direct communication connection(s) 228 may be provided via the network 204 between each regional controller subsystem 202b and each worker subsystem 206a, and direct communication connection(s) 230 may be provided via the network 204 between each user device 210 and each worker subsystem 206a. However, while a specific example of the communication connections in the networked system 202 have been illustrated and described, one of skill in the art in possession of the present disclosure will appreciate how the functionality discussed below may be enabled by a variety of other communication connections while remaining within the scope of the present disclosure as well.

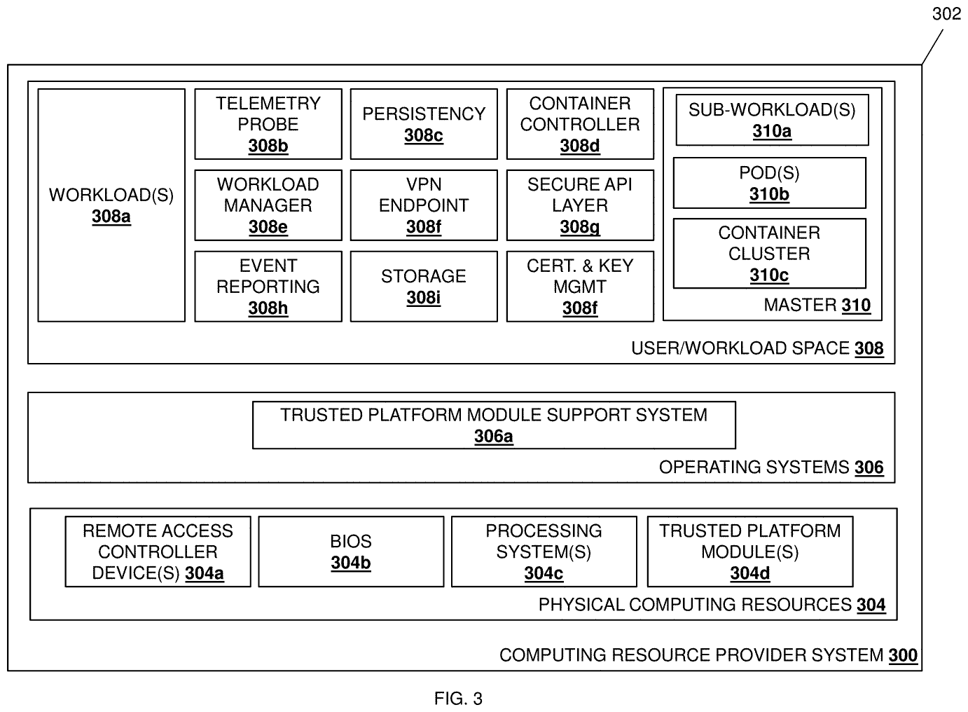

Referring now to FIG. 3, an embodiment of a computing resource provider system 300 is illustrated that may provide any of the computing resource provider system(s) 208 discussed above with reference to FIG. 2. As such, the computing resource provider system 300 may be provided by the IHS 100 discussed above with reference to FIG. 1 and/or may include some or all of the components of the IHS 100, and in the specific examples discussed below is described as including only server devices, but that may also (or instead) include server devices, switch devices, “smart” Network Interface Controller (smartNIC) devices, desktop computing devices, laptop/notebook computing devices, tablet devices, mobile phones, and/or any other computing devices that one of skill in the art in possession of the present disclosure would recognize as allowing the computing resource sharing operations discussed below. In the example illustrated and discussed with reference to FIG. 3, the computing resource provider system 300 includes the components of both the worker subsystem(s) 206a and the proxy subsystem(s) 214 discussed above with reference to FIG. 2. However, as discussed above, in some embodiments the proxy subsystem 214 may be provided by the computing resource provider system 300, the regional controller subsystem 202b, and/or the global controller subsystem 202a, and thus some or all of the proxy-providing components illustrated as included in the computing resource provider system 300 may be provided outside the computing resource provider system 300 while remaining within the scope of the present disclosure as well.

In the illustrated embodiment, the computing resource provider system 300 includes one or more chassis 302 that house the components of the computing resource provider system 300, only some of which are illustrated below. For example, the chassis 302 may house physical computing resources 304 that are illustrated in FIG. 3 as including remote access controller device(s) 304a (e.g., the integrated DELL® Remote Access Controller (iDRAC) included in server devices available from DELL® Inc. of Round Rock, Tex., United States), Basic Input/Output System(s) 304b, processing system(s) 304c, and Trusted Platform Module(s) (TPM(s)) 304d, but that one of skill in the art in possession of the present disclosure will appreciate may also include memory systems, storage systems, networking systems, and/or any other physical computing resources known in the art. One or more operating systems 306 may be provided by the physical computing resources 304, and in the illustrated embodiment include a TPM support system 306a. In a specific example, the computing resource provider system 300 includes one or more server devices whose computing resources will be shared via the computing resource sharing system of the present disclosure, and thus those server devices may include any of a variety of processing resources, memory resources, storage resources, networking resources, and/or other computing resources known in the art that may be shared as discussed below.

The chassis 302 may also house a user/workload space 308 that may be utilized for the performance of a variety of operations. For example, the user/workload space 308 may be utilized to perform workload operations 308a that may include host processes, functions and workloads that run on the system and are controlled through the system owner or subsequent host processes, and/or other workload operations known in the art. In a specific example, any of the workload operations 308a performed in the user/workload space 308 may have an execution priority (e.g., for the processing system/CPU) that prioritize their execution over foreign/outside workloads that are placed on the host system networked system 200 by the regional controller subsystem(s) 202b, discussed in further detail below.

In another example, the user/workload space 308 may be utilized to perform telemetry probe operations 308b that may enable the regional controller subsystem(s) 202b to monitor system health, monitor load and charging related metrics from the host, and/or other telemetry probe operations known in the art. In another example, the user/workload space 308 may be utilized to perform persistency operations 308c that may enable persistent container storage throughout the container workload lifecycle, with data persisted for a restricted time to enhance system performance for service re-instantiation in case of an earlier service termination. In another example, the user/workload space 308 may be utilized to perform container controller operations 308d that may utilize any container management system (or Lamda-function) to schedule the sub-workloads 310a discussed below that coexist with host workloads managed through a controller that may pre-emptively stop or migrate those sub-workloads 310a in overload situations.

In another example, the user/workload space 308 may be utilized to perform workload manager operations 308e that may operate to control the lifecycle (deployment, provisioning, start, pause, stop, termination, upgrade) of the sub-workloads 310a, pods 310b, and container cluster(s) 310c discussed below. In another example, the user/workload space 308 may be utilized to perform VPN endpoint operations 308f that may be utilized to secure layer 2 and layer 3 connections between subsystems (e.g., the worker subsystems, proxy subsystems, regional controller subsystem, and/or global controller subsystems discussed below). For example, the VPN endpoint operations may include the use of security keys that are generated locally on the worker subsystems and in the controller infrastructure, with security exposed throughout layers from the hardware into the containers in order to preserve trust, integrity and security when running foreign workloads on a remote system within a lightweight container management platform, and the data path provided via VPN and obfuscated to end users via one or more proxy subsystems that hides the topology and avoid resource identification.

In another example, the user/workload space 308 may be utilized to perform secure Application Programming Interface (API) operations 308g that provide a secure API layer to provide entry point(s) for the regional management and orchestration by the regional controller subsystem 202b over well-known endpoints in order to provide, for example, secure bootstrapping and operations. In another example, the user/workload space 308 may be utilized to perform event reporting operations 308h that may provide for proactive notifications to the controller infrastructure in the event of system changes that potentially or directly impair the host system or performance guarantees, with those changes to the host and/or its software processes monitored through the telemetry probes operations 308b discussed above, and with any associated events reported based on pre-defined thresholds or chronological measures.

In another example, the user/workload space 308 may be utilized to perform storage operations 308i that may include the block storage of large files such as firmware images or multimedia files. In another example, the user/workload space 308 may be utilized to perform certification and key management operations 308f that include the local generation of public key infrastructure and certificates during installation in order to allow workload execution, VPN establishment, and mutual authentication between architecture components, as well as authentication of workloads. However, while several examples of utilization of the user/workload space 308 have been described, one of skill in the art in possession of the present disclosure will recognize that a wide variety of other operations will fall within the scope of the present disclosure as well.

Furthermore, the user/workload space 308 may also be utilized to provide a master 310 that is configured to perform sub-workloads 310a that may be provided by external processes that are placed and requested for execution on the computing resource provider system 300 by the regional controller subsystem 202b. The master 310 may also be configured to provide pods 310b that provide a defacto standard in Kubernetes to describe resource groups, and that may be used to logically and virtually group the sub-workloads 310a, and that may also be grouped again on a higher level and distributed across multiple physical or virtualized nodes/systems. The master 310 may also be configured to provide container clusters 310c that may be utilized to execute virtualized container network functions and that are interconnected via virtual networks

One of skill in the art in possession of the present disclosure will recognize that any particular computing resource provider system 206/300 may include computing resources that are typically utilized by the computing resource provider, but that may be provided in the computing resource sharing system of the present disclosure in order to allow the computing resource consumer system(s) 208 to utilize those computing resources when they are unutilized by the computing resource provider. As discussed in the specific example provided above, the computing resource provider system 206/300 may include a plurality of server devices that are typically utilized by the computing resource provider during the daytime on weekdays, but not during the nighttime on weekdays or during the weekend, and that are provided in the computing resource sharing system of the present disclosure in order to allow the computing resource consumer system(s) 208 to utilize those server devices during the nighttime on weekdays and during the weekend. However, while a specific example of server devices is provided, one of skill in the art in possession of the present disclosure will appreciate that any computing resources (or a portion of computing resources) in a computing resource provider system may be provided in the computing resource sharing system of the present disclosure in order to allow the computing resource consumer system(s) to utilize those computing resources when they are unutilized while remaining within the scope of the present disclosure.

In the specific example illustrated in FIG. 3 in which the computing resource provider system 300 provides computing resources for both the worker subsystem(s) 206a and the proxy subsystem 214 discussed above with reference to FIG. 2, trust, integrity, and security may be preserved when performing workloads requested by the computing resource consumer system(s) 208 by providing a containerized workload environment for each workload that may be remotely controlled by the regional controller subsystem 202b (e.g., via a container management platform such as the Lightweight Kubernetes/K3s container management platform, other container management systems, Lamda-function-supporting serverless architecture, and/or other container management functionality that would be apparent to one of skill in the art in possession of the present disclosure), with security exposed into that containerized workload environment through the layers provided by the physical computing resources 304, the operating systems 306 and the user/workload space 308 illustrated in FIG. 3. As will be appreciated by one of skill in the art in possession of the present disclosure, the containerized workload environments discussed above may be provided as extensions to the operating systems in the computing resource provider systems 206 that include the shared computing resources that provide those workloads. Furthermore, the secure API layer operations 308g may provide a secure API layer may allow regional management and orchestration operations to be performed in association with the computing resource provider system 300 by the regional controller subsystem 202b using secure bootstrapping and other secure operations known in the art.

As such workloads native to the computing resource providers (i.e., workloads performed by the computing resource provider using the computing resources they control) may be scheduled and performed along with workloads that are requested by the computing resource consumers systems 208 that are performed and managed in the containerized workload environments discussed above. As will be appreciated by one of skill in the art in possession of the present disclosure, the performance of workloads requested by the computing resource consumers systems 208 using shared computing resources in the computing resource provider system 300 may be pre-emptively stopped and/or migrated from the computing resource provider system 300 (e.g., in overload situations). Further still, the use of the proxy subsystem(s) 214 allows for data path obfuscation to the user device(s) 210 that utilize the resources provided via the performance of the workloads using shared computing resources in the computing resource provider system 300 by hiding topologies, avoiding resource identification, and/or via other privacy techniques known in the art.

While not illustrated in FIG. 3, the chassis 302 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a computing resource provider engine that is configured to perform the functionality of the computing resource provider engines and/or computing resource provider systems discussed below. Furthermore, the chassis 302 may also house a communication system that is coupled to the computing resource provider engine (e.g., via a coupling between the communication system and the processing system) and that may be provided by a Network Interface Controller (NIC), wireless communication systems (e.g., BLUETOOTH®, Near Field Communication (NFC) components, WiFi components, cellular components, etc.), and/or any other communication components that one of skill in the art in possession of the present disclosure would recognize as allowing the communications discussed below. However, while a specific computing resource provider system 300 has been illustrated and described, one of skill in the art in possession of the present disclosure will recognize that computing resource provider systems (or other devices operating according to the teachings of the present disclosure in a manner similar to that described below for the computing resource provider system 300) may include a variety of components and/or component configurations for providing conventional functionality, as well as the functionality discussed below, while remaining within the scope of the present disclosure as well.

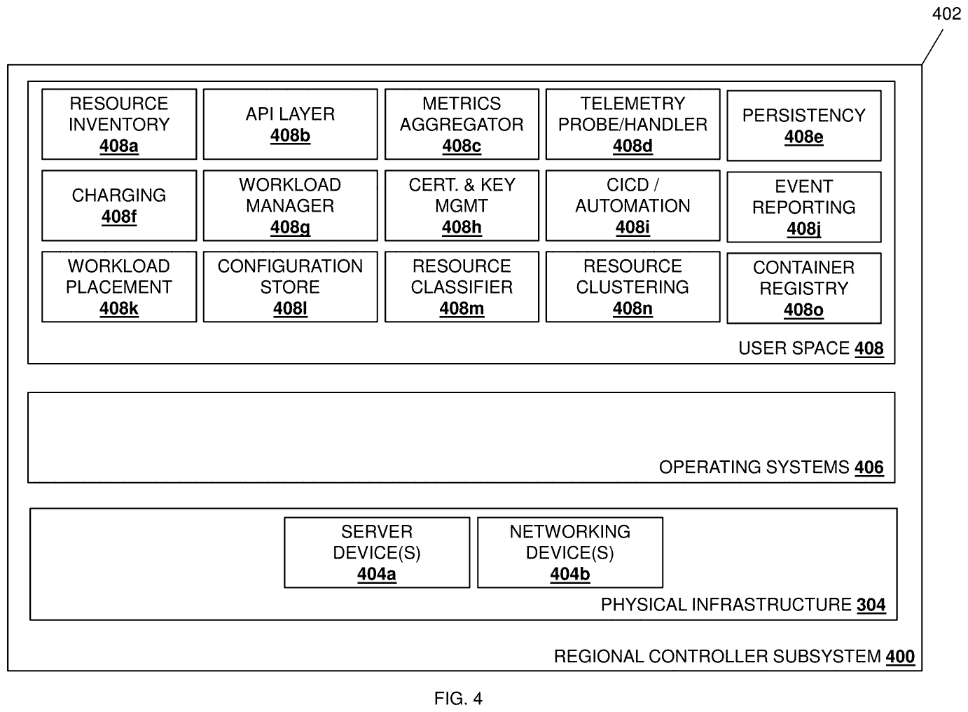

Referring now to FIG. 4, an embodiment of a regional controller subsystem 400 is illustrated that may provide any of the regional controller subsystem(s) 202b discussed above with reference to FIG. 2. As such, the regional controller subsystem 400 may be provided by the IHS 100 discussed above with reference to FIG. 1 and/or may include some or all of the components of the IHS 100, and in the specific examples discussed below is described as being provided by server devices. However, while described as being provided by server devices, one of skill in the art in possession of the present disclosure will recognize that the regional controller subsystem 400 may be provided by other devices that are configured to perform similarly as the regional controller subsystem 400 discussed below while remaining within the scope of the present disclosure as well. In the illustrated embodiment, the regional controller subsystem 400 includes one or more chassis 402 that house the components of the regional controller subsystem 400, only some of which are illustrated below.

For example, the chassis 402 may house physical infrastructure 404 that is illustrated in FIG. 4 as including one or more server devices 404a, one or more networking devices 404b (e.g., switch devices), and/or any other physical infrastructure known in the art. One or more operating systems 406 may be provided by the physical infrastructure 406 (e.g., on the server device(s) 404a). The chassis 402 may also house a user/workload space 408 that may be utilized for the performance of a variety of operations. For example, the user/workload space 408 may be utilized to perform resource inventory operations 408a that may provide a register of registered hosts systems together with required metadata for operations (e.g., metadata such as a number of CPUs/cores, memory device information, storage disk information, location information, and/or other metadata information known in the art).

In another example, the user/workload space 408 may be utilized to perform API layer operations 408b that may provide a secure API layer that provides a communication path to connected components such as other regional controller subsystem(s), global controller subsystem(s), worker subsystem(s), and/or proxy subsystem(s) described herein over well-known endpoints in order to provide, for example, secure bootstrapping and operations. In another example, the user/workload space 408 may be utilized to perform metrics aggregator operations 408c that may operate to clean, eventually normalize, and store incoming telemetry data using the results of the persistency operations 408e discussed below. In another example, the user/workload space 408 may be utilized to perform telemetry probe/handler operations 408d that provide the receiving side for the worker subsystem and proxy subsystem telemetry data and that may enable worker subsystem(s) or proxy subsystem(s) to monitor system health, load and charging related metrics from the host.

In another example, the user/workload space 408 may be utilized to perform persistency operations 408e that may enable persistent container storage throughout the container workload lifecycle, with data persisted for a restricted time to further enhance the system performance for service re-instantiation in case of an earlier service termination. In another example, the user/workload space 408 may be utilized to perform charging operations 408f that may be performed by analyzing telemetry data for usage with, for example, a number of service invocations, workload host duration, a number of workload instances, and consumed resources and their locations. In another example, the user/workload space 408 may be utilized to perform workload manager operations 408g that include a variety of workload management functionality that would be apparent to one of skill in the art in possession of the present disclosure. In another example, the user/workload space 408 may be utilized to perform certification and key management operations 408h that include a variety of certificate and key management functionality that would be apparent to one of skill in the art in possession of the present disclosure.

In another example, the user/workload space 408 may be utilized to perform Continuous Integration Continuation Delivery (CICD) automation operations 408i that may allow a service consumer to upload new releases of workload functions that will be rolled-out in a timely manner across the platform. In another example, the user/workload space 408 may be utilized to perform event reporting operations 408j that may be used to proactively notify the controller infrastructure in the event of system changes that potentially or directly impair the host system or performance guarantees. In another example, the user/workload space 408 may be utilized to perform workload placement operations 408k that may be used during system “rollout”, and that may utilize criteria and heuristics to best determine the number of service instances and their location given, for example, historical data and real-time measurements.

In another example, the user/workload space 408 may be utilized to perform configuration store operations 408l that include a variety of configuration store functionality that would be apparent to one of skill in the art in possession of the present disclosure In another example, the user/workload space 408 may be utilized to perform resource classifier operations 408m that may be performed to gather information about workloads and their estimated resource requirements under various load situations. In another example, the user/workload space 408 may be utilized to perform resource clustering operations 408n that include a variety of resource clustering functionality that would be apparent to one of skill in the art in possession of the present disclosure In another example, the user/workload space 408 may be utilized to perform container registry operations 408o that may provide a container endpoint for customers to upload network functions they are requesting for deployment. However, while several examples of utilization of the user/workload space 408 have been described, one of skill in the art in possession of the present disclosure will recognize that a wide variety of other operations will fall within the scope of the present disclosure as well.

As discussed below, the regional controller subsystem 400 may operate to perform shared computing resource inventory operations that include receiving shared computing resource information (e.g., Internet Protocol addresses, port identifiers, access keys, etc.) from the global controller subsystem(s) 202a and storing it in a local inventory maintained by that regional controller subsystem 400. Furthermore, the regional controller subsystem 400 may operate to perform shared computing resource classification operations that include measuring, evaluating, and classifying shared computing resource availability, connectivity (e.g., available bandwidth, associated “jitter”, etc.), reliability (e.g., “up-time”, previous graceful vs. abrupt shutdown operations, etc.), along with hardware characteristics (e.g., processing system characteristics, memory system characteristics, storage system characteristics, networking system characteristics, historic/predictive system loads), connectivity changes, and/or other shared resource classification information that would be apparent to one of skill in the art in possession of the present disclosure. In addition, the regional controller subsystem 400 may operate to perform shared computing resource clustering operations that include the analysis of geographical distance associated with the shared computing resources (e.g., based on latency, availability, throughput, reliability, matching resources, etc.) in order to provide optimized workload placement.

Further still, the regional controller subsystem 400 may operate to perform workload placement operations that include selecting the optimal placement of workloads for performance via shared computing resources in order to fulfill requirements such as availability, uptime, performance, bandwidth, historic/predictive system loads, and/or any other factors that would be apparent to one of skill in the art in possession of the present disclosure. In some embodiments, the workload placement operations performed by the regional controller subsystem 400 (discussed in further detail below) may be performed based on algorithms generated using Artificial Intelligence/Machine Learning (AI/ML) techniques or rules-based techniques that utilize previous measurements to predict future workloads and/or user data traffic patterns. Yet further still, the regional controller subsystem 400 may operate to perform workload manager operations that include the lifecycle management of the worker subsystems and 206a and proxy subsystems 214, the maintenance of topology, the changing of roles, the instantiation of new shared computing resources, the deactivation of unused shared computing resources, the requesting of metrics from computing resource provider system(s) 206, and/or any other workload management operations that would be apparent to one of skill in the art in possession of the present disclosure. Yet further still, the regional controller subsystem 400 may operate to perform metrics aggregator operations that include the monitoring of role-specific metrics generated by shared computing resource during their performance of workloads. However, while several specific operations are described as being performed by the regional controller subsystem 400, one of skill in the art in possession of the present disclosure will appreciate that the regional controller subsystem 400 may perform any other operations to enable the functionality described below while remaining within the scope of the present disclosure as well.

While not illustrated in FIG. 4, the chassis 402 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a regional controller sub-engine that is configured to perform the functionality of the regional controller sub-engines and/or regional controller sub-systems discussed below. For example, the computing resource sharing controller system 202 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a computing resource sharing controller engine that is configured to perform the functionality of the computing resource sharing controller engines and/or computing resource sharing controller systems discussed below, and the regional controller sub-engine may be included in that computing resource sharing controller engine.

Furthermore, the chassis 402 may also house a communication system that is coupled to the regional controller sub-engine (e.g., via a coupling between the communication system and the processing system) and that may be provided by a Network Interface Controller (NIC), wireless communication systems (e.g., BLUETOOTH®, Near Field Communication (NFC) components, WiFi components, cellular components, etc.), and/or any other communication components that one of skill in the art in possession of the present disclosure would recognize as allowing the communications discussed below. However, while a specific regional controller subsystem 400 has been illustrated and described, one of skill in the art in possession of the present disclosure will recognize that regional controller sub-systems (or other devices operating according to the teachings of the present disclosure in a manner similar to that described below for the regional controller subsystem 400) may include a variety of components and/or component configurations for providing conventional functionality, as well as the functionality discussed below, while remaining within the scope of the present disclosure as well.

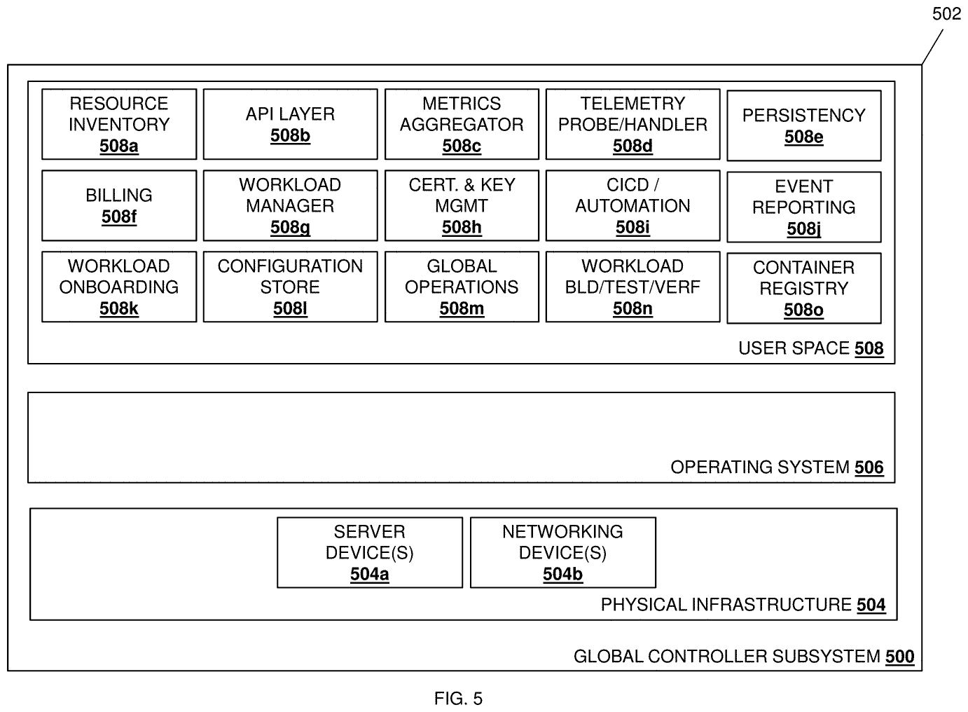

Referring now to FIG. 5, an embodiment of a global controller subsystem 500 is illustrated that may provide any of the global controller subsystem(s) 202a discussed above with reference to FIG. 2. As such, the global controller subsystem 500 may be provided by the IHS 100 discussed above with reference to FIG. 1 and/or may include some or all of the components of the IHS 100, and in the specific examples discussed below is described as being provided by server devices. However, while described as being provided by server devices, one of skill in the art in possession of the present disclosure will recognize that the global controller subsystem 500 may be provided by other devices that are configured to perform similarly as the global controller subsystem 500 discussed below while remaining within the scope of the present disclosure as well. In the illustrated embodiment, the global controller subsystem 500 includes one or more chassis 502 that house the components of the global controller subsystem 500, only some of which are illustrated below.

For example, the chassis 502 may house physical infrastructure 504 that is illustrated in FIG. 5 as including one or more server devices 504a, one or more networking devices 504b (e.g., switch devices), and/or any other physical infrastructure known in the art. One or more operating systems 506 may be provided by the physical infrastructure 506 (e.g., on the server device(s) 504a). The chassis 502 may also house a user/workload space 508 that may be utilized for the performance of a variety of operations. For example, the user/workload space 508 may be utilized to perform resource inventory operations 508a that may provide a register of regional controller subsystems. In another example, the user/workload space 508 may be utilized to perform API layer operations 508b to provide a secure API layer that provides the communication path to connected components such as other regional controller subsystem(s), global controller subsystem(s), worker subsystem(s) or proxy subsystem(s) over well-known endpoints for secure bootstrapping and operations.

In another example, the user/workload space 508 may be utilized to perform metrics aggregator operations 508c that may clean, eventually normalize, and store incoming telemetry data using the persistency operations 508e discussed below. In another example, the user/workload space 508 may be utilized to perform telemetry probe/handler operations 508d that may provide the receiving side for the worker subsystem and proxy subsystem telemetry data, and that may enable the global controller subsystem to monitor system health of the regional controller subsystem(s) and other adjacent global controller subsystem(s), load and charging related metrics from the host, and/or other information that would be apparent to one of skill in the art in possession of the present disclosure. In another example, the user/workload space 508 may be utilized to perform persistency operations 508e that may enable persistent container storage throughout the container workload lifecycle, with data persisted for a restricted time to further enhance the system performance for service re-instantiation in case of an earlier service termination.

In another example, the user/workload space 508 may be utilized to perform billing operations 508f that may include any of a variety of billing functionality that would be apparent to one of skill in the art in possession of the present disclosure. In another example, the user/workload space 508 may be utilized to perform workload manager operations 508g that may include any of a variety of workload management functionality that would be apparent to one of skill in the art in possession of the present disclosure. In another example, the user/workload space 508 may be utilized to perform certification and key management operations 508h that may include any of a variety of certification and key management functionality that would be apparent to one of skill in the art in possession of the present disclosure. In another example, the user/workload space 508 may be utilized to perform CICD automation operations 508i that may allow service consumers to upload new releases of workload functions that will be rolled-out in a timely manner across the platform (as well as control the supporting software function of the worker subsystems and regional controller subsystems as the global controller subsystem performs security and vulnerability scans (e.g., as part of the workload build, test and verification functions) of the uploaded network function before the network function gets deployed access the CICD pipelines of the regional controller subsystems).

In another example, the user/workload space 508 may be utilized to perform event reporting operations 508j that may be used to proactively notify the controller infrastructure in the event of system changes that potentially or directly impair the host system or performance guarantees. In another example, the user/workload space 508 may be utilized to perform workload onboarding operations 508k that may control uploads that allow customers to upload, modify and delete workload functions or container images (e.g., in a portal). In another example, the user/workload space 508 may be utilized to perform configuration store operations 508l that may include any of a variety of configuration store functionality that would be apparent to one of skill in the art in possession of the present disclosure. In another example, the user/workload space 508 may be utilized to perform global operations 508m that may include any of a variety of global functionality that would be apparent to one of skill in the art in possession of the present disclosure.

In another example, the user/workload space 508 may be utilized to perform workload build/test/verification operations 508n that may include any of a variety of workload build/test/verification functionality that would be apparent to one of skill in the art in possession of the present disclosure In another example, the user/workload space 508 may be utilized to perform container registry operations 508o that may include any of a variety of container registry functionality that would be apparent to one of skill in the art in possession of the present disclosure. However, while several examples of utilization of the user/workload space 408 have been described, one of skill in the art in possession of the present disclosure will recognize that a wide variety of other operations will fall within the scope of the present disclosure as well.

As discussed below, the global controller subsystem 500 may provide an entry portal for shared computing resource onboarding/registration and workload registration, and may operate to perform operations including virtual resource registration operations, container registry secure upload operations, uploading operations (e.g., uploading of helm charts, Cloud Service Archive (CSAR) files, Dockerfiles, docker-compose scripts, etc.), dry run/resource monitoring operations, security/vulnerability scan operations, customer selection operations (e.g., selections of availability zones, latency Service Level Agreements (SLAs), redundancy levels, custom port exposures, etc.), workload certification/rejection operations, and/or any other operations that would be apparent to one of skill in the art in possession of the present disclosure. In addition, the global controller subsystem 500 may orchestrate and/or manage the regional controller subsystem(s) 202b (e.g., including the clustering of the regional controller subsystem(s) 202b into availability zones), perform shared computing resource billing operations, perform shared computing resource compensation operations, and/or other global shared computing resource operations that would be apparent to one of skill in the art in possession of the present disclosure. However, while several specific operations are described as being performed by the global controller subsystem 500, one of skill in the art in possession of the present disclosure will appreciate that the global controller subsystem 500 may perform any other operations to enable the functionality described below while remaining within the scope of the present disclosure as well.

While not illustrated in FIG. 5, the chassis 502 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a regional controller sub-engine that is configured to perform the functionality of the regional controller sub-engines and/or regional controller sub-systems discussed below. For example, the computing resource sharing controller system 202 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a computing resource sharing controller engine that is configured to perform the functionality of the computing resource sharing controller engines and/or computing resource sharing controller systems discussed below, and the global controller sub-engine may be included in that computing resource sharing controller engine.

Furthermore, the chassis 502 may also house a communication system that is coupled to the global controller sub-engine (e.g., via a coupling between the communication system and the processing system) and that may be provided by a Network Interface Controller (NIC), wireless communication systems (e.g., BLUETOOTH®, Near Field Communication (NFC) components, WiFi components, cellular components, etc.), and/or any other communication components that one of skill in the art in possession of the present disclosure would recognize as allowing the communications discussed below. However, while a specific global controller subsystem 500 has been illustrated and described, one of skill in the art in possession of the present disclosure will recognize that global controller subsystems (or other devices operating according to the teachings of the present disclosure in a manner similar to that described below for the global controller subsystem 500) may include a variety of components and/or component configurations for providing conventional functionality, as well as the functionality discussed below, while remaining within the scope of the present disclosure as well.

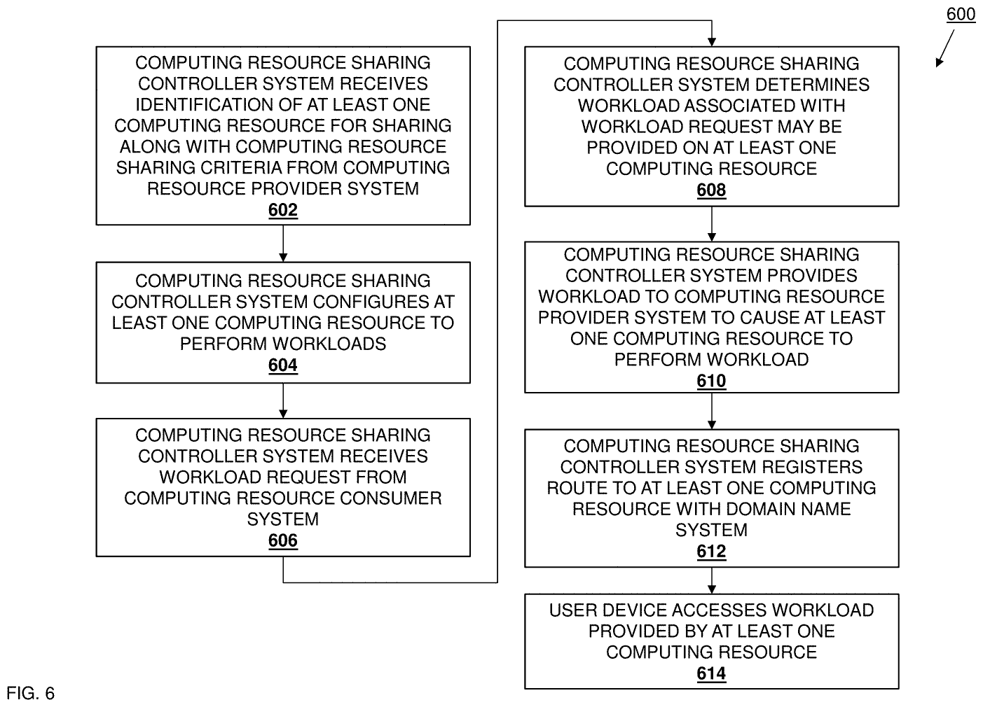

Referring now to FIG. 6, an embodiment of a method 600 for sharing computing resources is illustrated. As discussed below, the systems and methods of the present disclosure provide for the sharing of computing resources when they are not utilized in a computing resource provider system with computing resource consumers, which allows the computing resource provider to subsidize the cost of their computing resources, monetize those computing resources when they are unutilized, and may even incentivize the purchase of computing resources for the purposes of sharing them for profit. The computing resource sharing system of the present disclosure may provide a distributed global/regional computing resource sharing controller system that brokers computing resources between computing resource providers and computing resource consumers, thus enabling a “Cloud Resources as a Service” (CRaaS)/virtual cloud hosting model that allows a “virtual cloud provider” to offer cloud computing resources at a lower cost relative to conventional cloud providers due to the computing resource being hosted by the computing resource provider systems (thus offloading the hardware, networking, cooling, power, location/facility, maintenance costs and/or other datacenter costs from the virtual cloud provider), while the virtual cloud provider need only address computing resource reliability, security, privacy, availability, and performance via software as described below.

In the examples provided below, a single computing resource provider system shares one or more computing resources that are then utilized to perform a single workload requested by a single computing resource consumer system. For example, the performance of the workload requested by computing resource consumer system by the computing resources shared by the computing resource provider system may provide a banking website the enables a variety of banking functionality via a variety of banking resources known in art. However, one of skill in the art in possession of the present disclosure will appreciate how the computing resource sharing system of the present disclosure may manage computing resources shared by any number of computing resource provider systems, and then utilize those computing resources to perform any number of workloads requested by any number of computing resource consumer systems to provide any of number of resources while remaining within the scope of the present disclosure as well.

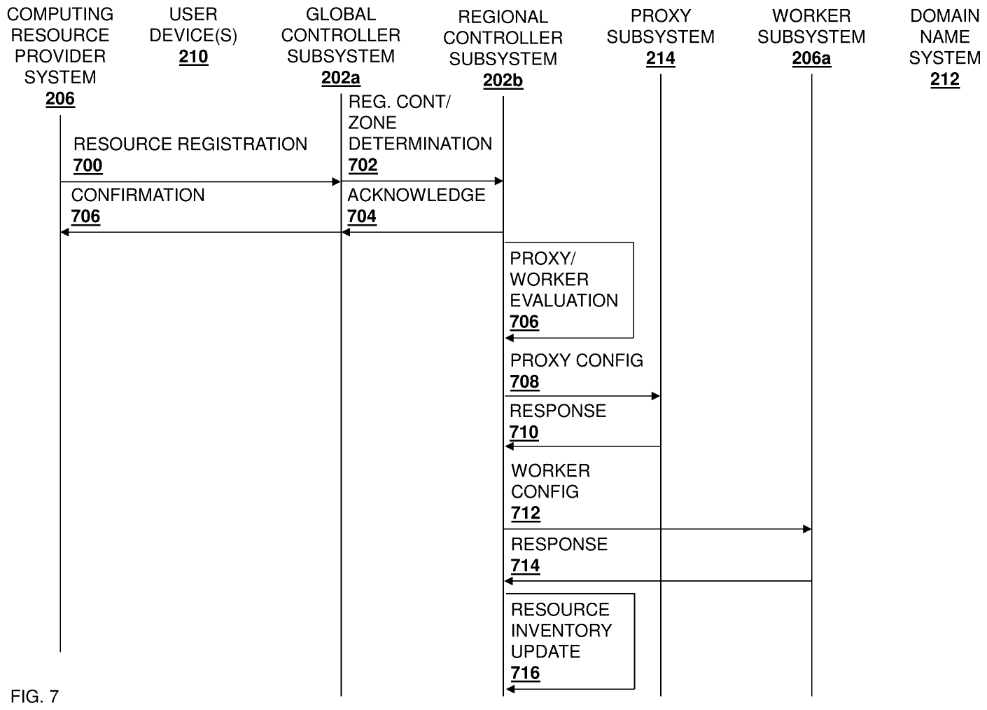

The method 600 begins at block 602 where a computing resource sharing controller system receives an identification of at least one computing resource for sharing along with computing resource sharing criteria from a computing resource provider system. With reference to FIG. 7, in an embodiment of block 602, the computing resource provider system 206 may register computing resources for sharing by transmitting a resource registration communication 700 to the global controller subsystem 202a. In specific examples, any computing resource provider system 206 may opt-in to offer up any of their computing resources to temporarily or permanently perform workloads requested by computing resource consumer system(s) 208 by, for example, allowing access to those computing resources via the remote access controller device(s) 304a, enabling the automated provisioning of those computing resources by the computing resource sharing controller system 202, and/or via any other techniques that would be apparent to one of skill in the art in possession of the present disclosure. As such, the resource registration communication 700 may include any communications that identify computing resources that are available for use in performing workloads requested by the computing resource consumer system(s) 208.

In an embodiment, at block 602, the regional controller subsystem 202b may perform the resource classifier operations 408m discussed above to provide an estimated assessment on the resource consumption of any network function. Furthermore, related information for dimensioning may be received from the computing resource provider system 206 while onboarding, and the dimensioning information may be compared against the host system telemetry data to identify both historic measurements and current real-time measurements that may be used to provide an assessment of the available resources. The regional controller subsystem 202b may then perform the workload placement operations 408k to provide such an assessment through a rule-based-algorithm, Reinforcement Learning/Machine Learning algorithm, and/or using other workload assessment techniques that would be apparent to one of skill in the art in possession of the present disclosure.

Furthermore, the computing resource provider system 206 may also define computing resource sharing criteria for the use of its computing resources, and may include that computing resource sharing criteria in the resource registration communication 700. In some embodiments, the computing resource sharing criteria may define a variety of usage patterns and/or policies that will be allowed for the shared computing resources. For example, usage patterns and/or policies defined by the computing resource sharing criteria may define the maximum utilization of computing resources in the computing resource provider system 206 to perform workloads requested by the computing resource consumer system(s) 208, with that utilization pre-empted only when the computing resource provider needs those computing resources to perform their own workloads. In another example, usage patterns and/or policies defined by the computing resource sharing criteria may define time-based/scheduled utilization of the computing resources in the computing resource provider system 206 to perform workloads requested by the computing resource consumer system(s) 208 during particular time periods (e.g., during the nighttime on weekdays and all day on weekends in the specific example provided above).

In yet another example, usage patterns and/or policies defined by the computing resource sharing criteria may provide for resource-based/quota utilization of the computing resources in the computing resource provider system 206 to perform workloads requested by the computing resource consumer system(s) 208 by dedicating a subset of the available computing resources in the computing resource provider system 206 (e.g., a maximum of 8 processing cores, 1 GB of Random Access Memory (RAM), 1 TB of storage space, 6 Mbps uplink bandwidth, etc.) to perform workloads requested by the computing resource consumer system(s) 208. In yet another example, usage patterns and/or policies defined by the computing resource sharing criteria may provide for fixed maximum ratio utilization of the computing resources in the computing resource provider system 206 to perform workloads requested by the computing resource consumer system(s) 208 by dedicating a maximum amount of the system load available from the computing resources in the computing resource provider system 206 (e.g., a maximum of 30% of the system load) to perform workloads requested by the computing resource consumer system(s) 208. However, while a few specific examples have been described above, one of skill in the art in possession of the present disclosure will appreciate how combinations of the computing resource sharing criteria above, as well as other computing resource sharing criteria, may be provided to define the allowed utilization of the shared computing resources while remaining within the scope of the present disclosure as well.

In some embodiments, the global controller subsystem 202a may require computing resources provided for sharing by the computing resource provider systems 206 to provide a minimum Service Level Agreement (SLA) or other performance metrics. For example, the shared computing resources and/or their computing resource sharing criteria may be required to provide shared computing resource uptime of at least one uninterrupted hour per day. However, one of skill in the art in possession of the present disclosure will appreciate how shared computing resources may be required to exhibit minimum processing system capabilities, minimum memory system capacity, minimum storage capacity, minimum networking bandwidth, maximum latency, and/or other capabilities in order to be shared in the computing resource sharing system of the present disclosure.

In some embodiments, the global controller subsystem 202a may control the compensation for shared computing resources that is provided to the computing resource provider when those shared computing resources are utilized to perform workloads by the computing resource consumers system(s) 208, and that compensation may be defined during the registration of those computing resources. For example, compensation for shared computing resources may be based on actual computing resource consumption (e.g., processing system consumption, memory system consumption, storage system consumption, networking bandwidth consumption, etc.) as measured per time interval, computing resource consumption timing (e.g., utilization during “peak” hours may be compensated differently than utilization during “off-peak” hours), computing resource location (e.g., computing resources in urban areas may be compensated differently than computing resources in rural areas), computing resource latency (the utilization of low-latency computing resources may be compensated differently than the utilization of high-latency computing resources), relative computing resource utilization (e.g., the utilization of computing resources in high demand may be compensated differently than the utilization of computing resources in low demand), and/or based on a variety of other compensation factors that would be apparent to one of skill in the art in possession of the present disclosure.

For any computing resources shared by the computing resource provider system 206, the global controller subsystem 202a may request metrics for those computing resources in order to, for example, perform periodic performance monitoring and/or health checks on those computing resources. As such, the computing resource provider system 202a may push computing resource reports, computing resource telemetry data, and/or other metrics for any shared computing resource as requested by the global controller subsystem 202a. Thus, the global controller subsystem 202a may utilize metrics received from the computing resource provider system 202a to monitor the scale and number of worker subsystems 206a and proxy subsystems 214 deployed, computing resource/operating system loads (e.g., processing system/Central Processing Unit (CPU) loads), computing resource utilization (e.g., storage, memory, processing, and/or networking utilization), real-time computing resource measurements, historical computing resource measurements, as well as reliability/stability metrics such as systems uptime/downtime, participation duration, errors generated, network jitter, network delays, peak throughput, average utilization, computing resource capacity (e.g., processing system capacity, memory system capacity, storage system capacity, and/or networking system capacity), storage system speed and size, software versions, and/or any other metrics that would be apparent to one of skill in the art in possession of the present disclosure. Furthermore, the metrics received from the computing resource provider system 202a may be utilized by the global controller subsystem 202a to evaluate and qualify shared computing resources that perform workloads reliably, and such qualified shared computing resources may be prioritized for performing workloads in the computing resource sharing system of the present disclosure.

Referring back to FIG. 7, in response to receiving the resource registration communication 700 and following any computing resource validation operations (e.g., the minimum performance/SLA requirements discussed above) that qualify those computing resources for sharing in the computing resource sharing system of the present disclosure, the global controller subsystem 202a may then perform regional controller/zone determination operations 702 that operate to select a regional controller subsystem 202b for managing the computing resources being registered by the computing resource provider system 206. In some embodiments, the global controller subsystem 202a may cluster regional controller subsystems 202b into availability zones, which may dictate which regional controller subsystems 202b manage shared computing resources. For example, regional controller subsystems 202b may be associated with geographic availability zones, and when a computing resource provider system in a particular geographic area shares computing resources, a regional controller subsystem 202b in a geographic availability zone that corresponds to that particular geographic area may be identified for managing those shared computing resources. However, while specific (geographic) criteria has been provided as an example of how regional controller subsystems may be selected to manage shared computing resources, one of skill in the art in possession of the present disclosure will appreciate that other criteria for selecting regional controller subsystems to manage shared computing resources will fall within the scope of the present disclosure as well.

As can be seen in FIG. 7, in response to being selected to manage the computing resources shared by the computing resource provider system 206 as part of the regional controller/zone determination operations 702 and as discussed above, the regional controller subsystem 202b may receive computing resource IP addresses, computing resource port identifiers, computing resource access keys, and/or other computing resource access information about the computing resources shared by the computing resource provider system 202a, and may store that computing resource access information in its local inventory/database. As also discussed above, in response to being selected to manage the shared computing resources in the computing resource provider system 206, the regional controller subsystem 202a may perform shared computing resource classification operations that include measuring, evaluating, and classifying shared computing resource availability, connectivity (e.g., available bandwidth, associated “jitter”, etc.), reliability (e.g., “up-time”, previous graceful vs. abrupt shutdown operations, etc.), along with hardware characteristics (e.g., processing system characteristics, memory system characteristics, storage system characteristics, networking characteristics, historic/predictive system loads), connectivity changes, and/or other shared resource classification information that would be apparent to one of skill in the art in possession of the present disclosure.

In addition, the regional controller subsystem 202b may also operate to perform shared computing resource clustering operations that include the analysis of geographical distance associated with the shared computing resources (e.g., based on latency, availability, throughput, reliability, matching resources, etc.) in order to provide optimized workload placement, discussed below. As illustrated in FIG. 7, the regional controller subsystem 202b may then transmit an acknowledgement communication 704 to the global controller subsystem 202a and, in response, the global controller subsystem 202a may transmit a confirmation communication 706 to the computing resource provider system 206 that confirms the registration of the shared computing resources.

The method 600 then proceeds to block 604 where the computing resource sharing controller system configures the at least one computing resource to perform workloads. In an embodiment, at block 604, the regional controller subsystem 202b may operate to configure the computing resources shared by the computing resource provider system 206 to perform workloads. With reference to FIG. 7, at block 604, the regional controller subsystem 202b may perform proxy/worker evaluation operations 706 to evaluate how the computing resources shared by the computing resource provider system 206 may be configured to provide the worker subsystem(s) 206a and, in some cases the proxy subsystem(s) 214.

In an embodiment, the resource assessment and testing operations discussed above allow the system reliability to be measured based on, for example, 1) constant time online and number of outages over a given time period, as well as based on 2) the performance, type, and quality of the network connection (e.g., measured in jitter, throughput, packet loss, and utilization rate over time) and based on 3) processing capacities, memory capabilities, and storage capabilities. As such, systems with a relatively positive evaluation for points 1) and 2) above may fall into the category of a proxy (which performs a relatively higher amount of data transport functions), while systems with a relatively positive evaluation for points 1) and 3) above are candidates for a worker subsystem (which performs a relatively high amount of processing functions).

As discussed above, in some embodiments the proxy subsystem(s) 214 may be provided using the shared computing resources in the computing resource provider system 206, physical infrastructure 404 in the regional controller subsystems 208/400, and/or physical infrastructure 504 in the global controller subsystem(s) 206/500. As such, following the proxy/worker evaluation operations 706, the regional controller subsystem 202b may have identified the shared computing resources in the computing resource provider system 206, physical infrastructure 404 in the regional controller subsystems 208/400, and/or physical infrastructure 504 in the global controller subsystem(s) 206/500, for use in providing the proxy system(s) 214. In response, the regional controller subsystem 202b may perform proxy configuration operations 708 in order to configure the shared computing resources in the computing resource provider system 206, physical infrastructure 404 in the regional controller subsystems 208/400, and/or physical infrastructure 504 in the global controller subsystem(s) 206/500, to provide the proxy system(s) 214. Subsequent to configuration, the proxy system(s) 214 may then transmit response communications 710 to the regional controller subsystem 202b.

Similarly, following the proxy/worker evaluation operations 706, the regional controller subsystem 202b may have identified the shared computing resources in the computing resource provider system 206 for use in providing the worker system(s) 206a. In response, the regional controller subsystem 202b may perform worker configuration operations 712 in order to configure the shared computing resources in the computing resource provider system 206 to provide the worker system(s) 206a. Subsequent to configuration, the worker system(s) 206a may then transmit response communications 714 to the regional controller subsystem 202b. Following configuration of the proxy system(s) 214 and the worker system(s) 206a for the shared computing resources in the computing resource provider system 206, the regional controller subsystem 202b may perform resource inventory update operations 716 to update its shared computing resource inventory to include the shared computing resources in the computing resource provider system 206.

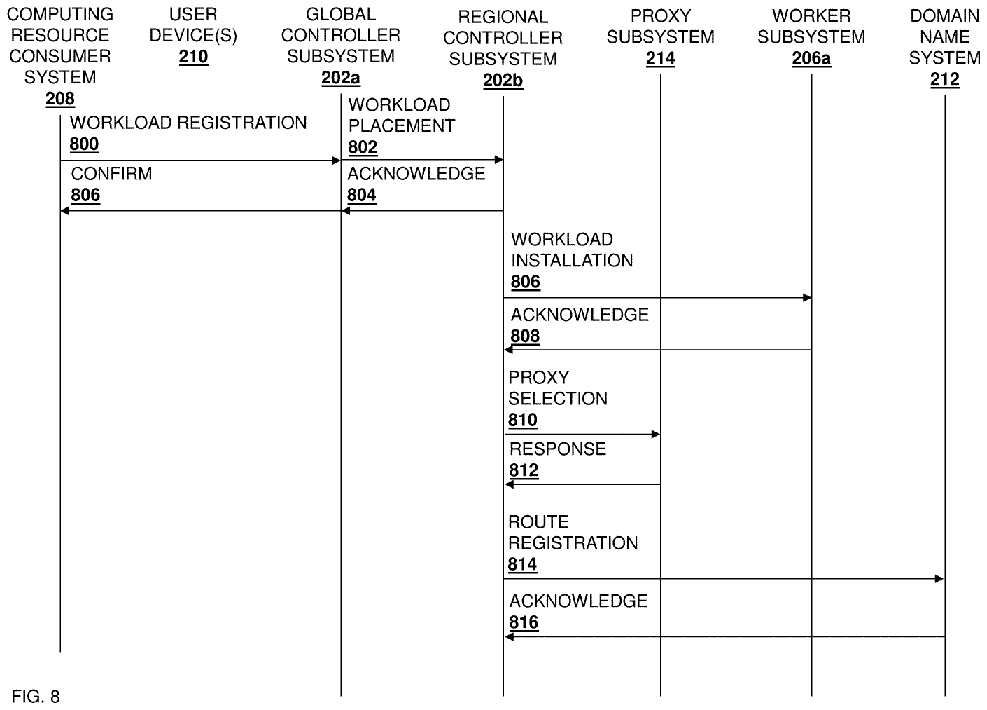

The method 600 then proceeds to block 606 where the computing resource sharing controller system receives a workload request from a computing resource consumer system. With reference to FIG. 8, in an embodiment of block 606, the computing resource consumer system 208 may perform workload registration operations that include transmitting a workload registration communication 800 to the global controller subsystem 202a that includes a workload request to perform a workload using shared computing resources in the shared computing resource system of the present disclosure. In some embodiments, the workload request may include workload performance criteria that may include, for example, a particular time period during which the workload should be performed, a maximum/SLA latency for performance of the workload, a minimum processing capability for performance of the workload, a minimum memory capability for performance of the workload, a minimum storage capability for performance of the workload, a minimum networking bandwidth for performance of the workload, a particular availability zone for performing the workload, a redundancy level for performing the workload, a custom port exposure for performing the workload, and/or any of the variety of other workload performance factors that would be apparent to one of skill in the art in possession of the present disclosure.

In an embodiment, in response to receive the workload request, the global controller subsystem 202a may perform a security analysis of the workload to determine that the workload is secure. For example, at block 606 and as discussed above, the global controller subsystem 202a may perform security and vulnerability scan operations on the workload requested by the computing resource consumer system 208, which may utilize a variety of security techniques known in the art to either certify the workload for performance on the shared computing resources, or reject the workload so that it may not be performed on the shared computing resources. In a specific example, safety and security may be evaluated to provide safety for the host system and security for the workload running on the host system, and a data retention policy may be utilized to remove sensitive and non-sensitive data after this data is no longer used in order to provide for high performance task execution.

The method 600 then proceeds to block 608 where the computing resource sharing controller system determines a workload associated with the workload request may be provided by the at least one computing resource. With reference to FIG. 8, in an embodiment of block 608, the global controller subsystem 202a may perform workload placement operations 802 that may include utilizing the workload performance criteria included in the workload request to identify the regional controller subsystem 202b for managing the workload, and informing the regional controller subsystem 202b of its selection to manage the workload. In response to being selected to manage the workload, the regional controller subsystem 208 may transmit an acknowledge communication 804 to the global controller subsystem 202a and, in response, the global controller subsystem 202a may then transmit a confirmation communication 806 to the computing resource consumer system 208 to confirm the registration and placement of the workload on the shared computing resources.

The method 600 then proceeds to block 610 where the computing resource sharing controller system provides the workload to the computing resource provider system to cause the at least one computing resource to perform the workload. With reference to FIG. 8, in an embodiment of block 610 and following its selection to manage the workload, the regional controller subsystem 202b may perform workload installation operations 806 to identify a worker subsystem 206a provided on shared computing resources in the computing resource provider system 206, and provide that workload on that worker subsystem 206a. For example, following its selection to manage the workload, the regional controller subsystem 202b may identify shared computing resources that fulfill the computing resource sharing criteria and the workload performance criteria discussed above that may define the availability, uptime, performance, bandwidth, historic/predictive systems loads, and/or other characteristics available from the shared computing resources and/or required to perform the workload, which may provide an optimized placement of the workload on the worker subsystem(s) 206a. As will be appreciated by one of skill in the art in possession of the present disclosure, in many cases multiple shared computing resources may be sufficient to perform the workload, and thus the shared computing resource that is actually selected to perform the workload may be selected using load-balancing techniques to ensure workloads are distributed amongst the available shared computing resources in the computing resource sharing system.

As discussed above, workload placement, execution and subsequent access (discussed below) may be secured via the chain of trust container execution environment. In a specific example, such security may be provided at the hardware layer with the use of built-in Trusted Platform Management (TPM) chips that allow secure BIOS and bootloader executions, and that enable secure Operating System boots. In turn, a PKI may be utilized by the Operating System to secure the container management systems and containers, and containers may execute their workloads securely in parallel while being enabled to securely communicate through standard interfaces over well-defined APIs. Specific examples for API protocols may include Hypertext Transfer Protocol Secure (HTTPS) techniques next to TLS/SSL, certificates, proxies and/or firewalls, which one of skill in the art in possession of the present disclosure will recognize. may be utilized per computing resource/device for any services provided via the performance of workloads. Furthermore, the TLS connections discussed above may be utilized for API traffic, encrypted overlays, and tunnels provided with containers and Container Network Interfaces (CNIs). Further still, for the Lightweight Kubernetes/K3s containerized workload environments discussed above, Role-Based Access Control (RBAC), TLS connections for API traffic, namespaces, work-load isolation, network policies, control-privileged containers, restricted access to ETCD key stores, and relatively frequent infrastructure credential rotation may be employed. Yet further still, for the Docker containerized workload environments discussed above, a trusted Docker engine, a trust registry, and a Docker Content Trust (DCT) may be employed. Finally, for the shared computing resources performing the workloads, an operating system firewall may be employed on a per device/computing resource basis, signed operating system bootloaders, operating systems, and firmware may be utilized, signed BIOS may be utilized, and the hardware and TPMs may be associated with an immutable fused key and Read-Only-Memory (ROM) code.

As such, following the workload installation operations 806, the worker subsystem 206a may transmit an acknowledge communication 808, and following the receipt of the acknowledge communication 808, the regional controller subsystem 202b may perform proxy selection operations 810 to select the proxy subsystem 214 for use in transmitting communications between the user device(s) 210 and the worker subsystem 206a. In some embodiments, the proxy subsystem 214 may be utilized for any access to the worker subsystem 206a, and thus the selection of the proxy subsystem 214 may be based on the proxy subsystem 214 providing at least minimum networking bandwidth requirements for the workload. However, while the selection of the proxy subsystem 214 based on specific criteria has been described, one of skill in the art in possession of the present disclosure will appreciate how the proxy system 214 may be selected based on other criteria while remaining within the scope of the present disclosure as well. In response to being selected as the proxy subsystem 214 as part of the proxy selection operations 810, the proxy subsystem 214 may transit a response communication 812 to acknowledge that selection.

The method 600 then proceeds to block 612 where the computing resource sharing controller system registers a route to the at least one computing resource with a domain name system. With reference to FIG. 8, in an embodiment of block 612 and following the installation of the workload on the workload subsystem 206a and the selection of the proxy subsystem 214 for transmitting communications to and from the workload subsystem 206a, the regional controller subsystem 202b may perform route registration operations 814 to register a route to the workload performed by the workload subsystem 206a via the proxy subsystem 214 by, for example, performing a hash operation on a proxy subsystem identifier and workload identifier to generate a hash value (e.g., hash[proxyID, workloadID], and then using that hash value to generate a route (e.g., hash[proxyID, workloadID].provider.com) that it may then register with the domain name system 212. In response to receiving the route as part of the route registration operations 814, the domain name system 212 may respond by transmitting an acknowledge communication 816 to confirm the registered route.

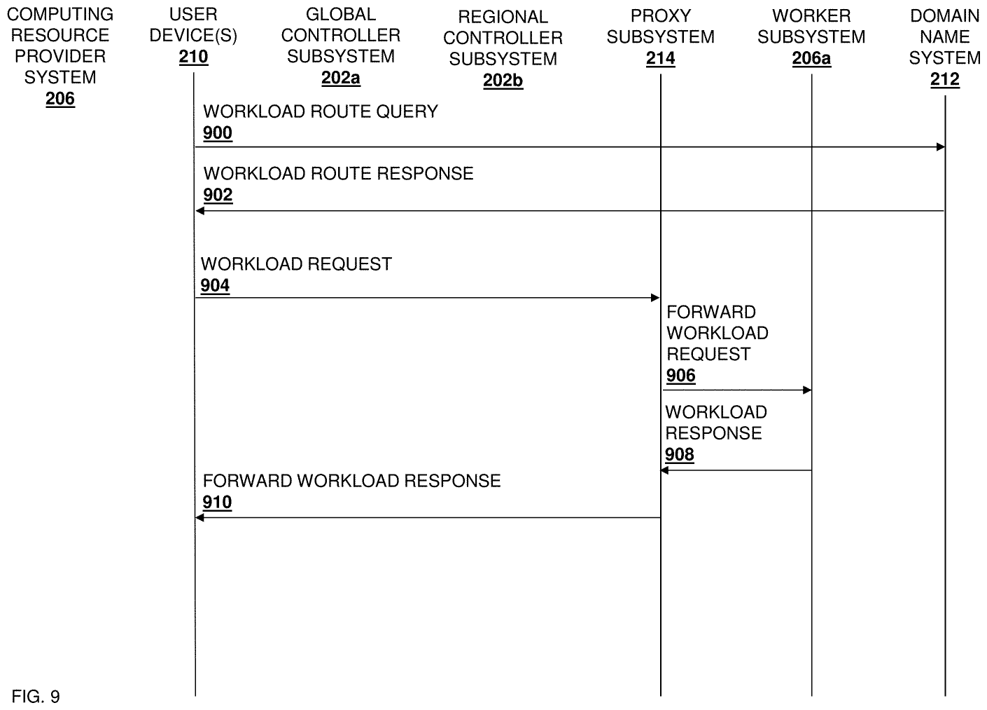

The method 600 then proceeds to block 614 where a user device accesses the workload provided by the at least one computing resource. Subsequent to the installation of the workload on the workload subsystem 206a, the selection of the proxy subsystem 214 for transmitting communications between the user device(s) 210 and the workload subsystem 206a, and the registration of the route to the workload performed by the workload subsystem 206a via the proxy subsystem 214, the user device(s) 210 may utilize that route to access resources provided via the performance of the workload. For example, with reference to FIG. 9, user device(s) 210 may perform workload route query operations 900 to request a route to the workload performed by the workload system 206a from the domain name system 212. In response to receiving the request for the route to the workload performed by the workload system 206a as part of the workload route query operations 900, the domain name system 212 may response by transmitting a workload route response communication 902 that may include the route (e.g., hash[proxyID, workloadID].provider.com in the example above) that was registered with the domain name system 212 as discussed above.

In an embodiment, at block 614, the user device(s) 210 may then use the route (e.g., hash[proxyID, workload ID].provider.com in the example above) received from the domain name system 212 to perform workload request operations 904 with the proxy subsystem 214 to transmit a request for the workload being performed by the workload subsystem 206a, and in response to receiving the workload request as part of the workload request operations 904, the proxy subsystem 214 may perform workload request forwarding operations 906 to forward that request to the worker subsystem 206a. In response to receiving the forwarded workload request as part of the workload request forwarding operations 906, the worker subsystem 206a may perform workload response operations 908 (as part of performing the workload) to generate a workload response, and may transmit that workload response to the proxy subsystem 214. In response to receiving the workload response as part of the workload response operations 908, the proxy subsystem 214 may perform workload response forwarding operations 910 to forward the workload response to the user device(s) 210. As will be appreciate by one of skill in the art in possession of the present disclosure, the workload request/response operations discussed above allow the user device(s) 210 to access resources provided via the performance of the workload using the shared computing resources on the computing resource provider system 206 at the request of the computing resource consumer system 208. Thus, continuing with the specific example above in which the workload provides a banking website with banking functionality, the user device(s) 210 may utilize the banking functionality and banking website that result from the performance of the workload to perform any of a variety of banking operations known in the art.

In some embodiments, networks that provide access to shared computing resources may utilize Network Address Translation (NAT) in a manner that prevents port forwarding, and solutions such as Session Traversal Utilities for NAT (STUN), Traversal Using Relay around NAT (TURN), or Interactive Connectivity Establishment (ICE) may be incorporated into the computing resource sharing system of the present disclosure in order to address associated issues. For example, the worker subsystems 206a and proxy subsystems 214 may use STUN to discover their public IP addresses when located behind a NAT/firewall operating with private IP addresses which are not routable, with the proxy subsystem 214 acting as a TURN to relay communications between user devices 210 and worker subsystems 206a, and with the worker subsystems 206a and proxy subsystems 214 using ICE to coordinate STUN and TURN to establish connections between hosts.

As discussed above, the computing resource provider that controls the computing resource provider system 206 may subsequently be compensation for shared computing resources when those shared computing resources are utilized to perform workloads by the computing resource consumers systems 208, and that compensation may be based on any of the compensation factors discussed above. As such, in some embodiments, the global controller subsystem 202a may monitor the workload performance metrics discussed above that result from the performance of workloads by the shared computing resources in the computing resource provider system 206, may perform billing operations to bill the computing resource consumer that controls the computing resource consumer system 208 that requested the performance of those workloads, and may compensate the computing resource provider that controls the computing resource provider system 206 out of the payments made by the computing resource consumer in response to those billing operations.

Thus, systems and methods have been described that provide for the sharing of computing resources when they are not utilized in a computing resource provider system with computing resource consumers, which allows the computing resource provider to subsidize the cost of their computing resources, monetize those computing resources, and may even incentivize the purchase of computing resources for the purposes of sharing them for profit. The computing resource sharing system of the present disclosure may provide a distributed global/regional computing resource sharing controller system that brokers computing resources between computing resource providers and computing resource consumers, thus enabling a “Cloud Resources as a Service” (CRaaS)/virtual cloud hosting model that allows a virtual cloud provider to offer cloud resources at a lower cost relative to conventional cloud providers due to the computing resource being hosted by the computing resource provider systems (thus offloading the hardware, networking, cooling, power, location/facility, and maintenance costs), and with the virtual cloud provider addressing computing resource reliability, security, privacy, availability, and performance via software as described above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A computing resource sharing system, comprising:
a computing resource provider system;
a computing resource consumer system;
a computing resource sharing controller system that is coupled to the computing resource provider system and the computing resource consumer system via a network, wherein the computing resource sharing controller system is configured to:
receive, from the computing resource provider system via the network, an identification of at least one computing resource included in the computing resource provider system for sharing, and computing resource sharing criteria defining how the at least one computing resource may be shared;
receive, from the computing resource consumer system via the network and subsequent to receiving the identification of the at least one computing resource and the computing resource sharing criteria, a workload request associated with a workload;
determine, based on the computing resource sharing criteria, that the workload associated with the workload request may be provided by the at least one computing resource; and
provide, in response to determining that the workload may be provided by the at least one computing resource, the workload via the network to the computing resource provider system to cause the at least one computing resource to perform the workload.

2. The system of claim 1, wherein the computing resource sharing controller system is configured to:
perform, in response to receiving the workload request, a security analysis of the workload to determine that the workload is secure, wherein the workload is provided via the network to the computing resource provider system in response to determining that the workload is secure.

3. The system of claim 1, wherein the computing resource sharing criteria includes a computing resource sharing time period during which the at least one computing resource may be shared, and wherein the workload request includes a workload performance time period during which the workload should be performed and that falls within the computing resource sharing time period.

4. The system of claim 1, wherein the computing resource sharing controller system includes:
a global controller subsystem that is configured to:
receive, from the resource provider system via the network, the identification of at least one computing resource included in the computing resource provider system for sharing, and computing resource sharing criteria defining how the at least one computing resource may be shared and, in response, identify a regional controller subsystem for controlling the at least one computing resource; and
receive, from the resource consumer system via the network and subsequent to receiving the identification of the at least one computing resource and the computing resource sharing criteria, the workload request associated with the workload and, in response, identify the regional controller subsystem for placing the workload; and
the regional controller subsystem that is configured, in response to being identified to control the at least one computing resource and place the workload by the global controller subsystem, to:
determine, based on the computing resource sharing criteria, that the workload associated with the workload request may be provided by at least one computing resource; and
provide, in response to determining that the workload may be provided by at least one computing resource, the workload via the network to the computing resource provider system to cause the at least one computing resource to perform the workload.

5. The system of claim 1, wherein the computing resource sharing controller system is configured to:
configure, in response to receiving the identification of at least one computing resource included in the computing resource provider system for sharing, the at least one computing resource to provide:
at least one worker subsystem that is configured to perform workloads; and
at least one proxy subsystem that is configured to transmit workload communications to and from the at least one worker subsystem.

6. The system of claim 1, wherein the computing resource sharing controller system is configured to:
register, in response to that the workload may be provided by the at least one computing resource, a route to the at least one computing resource in a domain name system, wherein the route is configured for use by a user device to communicate with the workload performed by the at least one computing resource.

7. An Information Handling System (IHS), comprising:
a processing system; and
a memory system that is coupled to the processing system and that includes instructions that, when executed by the processing system, cause the processing system to provide a computing resource sharing controller engine that is configured to:
receive, from a computing resource provider system via the network, an identification of at least one computing resource included in the computing resource provider system for sharing, and computing resource sharing criteria defining how the at least one computing resource may be shared;
receive, from a computing resource consumer system via the network and subsequent to receiving the identification of the at least one computing resource and the computing resource sharing criteria, a workload request associated with a workload;
determine, based on the computing resource sharing criteria, that the workload associated with the workload request may be provided by the at least one computing resource; and
provide, in response to determining that the workload may be provided by the at least one computing resource, the workload via the network to the computing resource provider system to cause the at least one computing resource to perform the workload.

8. The IHS of claim 7, wherein the computing resource sharing controller engine is configured to:
perform, in response to receiving the workload request, a security analysis of the workload to determine that the workload is secure, wherein the workload is provided to the at least computing resource provider in response to determining that the workload is secure.

9. The IHS of claim 7, wherein the computing resource sharing criteria includes a computing resource sharing time period during which the at least one computing resource may be shared, and wherein the workload request includes a workload performance time period during which the workload should be performed and that falls within the computing resource sharing time period.

10. The IHS of claim 7, wherein the computing resource sharing controller engine includes:
a global controller sub-engine that is configured to:
receive, from the resource provider system via the network, the identification of at least one computing resource included in the computing resource provider system for sharing, and computing resource sharing criteria defining how the at least one computing resource may be shared and, in response, identify a regional controller sub-engine for controlling the at least one computing resource; and
receive, from the resource consumer system via the network and subsequent to receiving the identification of the at least one computing resource and the computing resource sharing criteria, the workload request associated with the workload and, in response, identify the regional controller sub-engine for placing the workload; and
the regional controller sub-engine that is configured, in response to being identified to control the at least one computing resource and place the workload by the global controller sub-engine, to:
determine, based on the computing resource sharing criteria, that the workload associated with the workload request may be provided by at least one computing resource; and
provide, in response to determining that the workload may be provided by at least one computing resource, the workload via the network to the computing resource provider system to cause the at least one computing resource to perform the workload.

11. The IHS of claim 7, wherein the computing resource sharing controller engine is configured to:
configure, in response to receiving the identification of at least one computing resource included in the computing resource provider system for sharing, the at least one computing resource to provide:
at least one worker subsystem that is configured to perform workloads; and
at least one proxy subsystem that is configured to transmit workload communications to and from the at least one worker subsystem.

12. The IHS of claim 7, wherein the computing resource sharing controller engine is configured to:
register, in response to determining that the workload may be provided by the at least one computing resource, a route to the at least one computing resource in a domain name system, wherein the route is configured for use by a user device to communicate with the workload performed by the at least one computing resource.

13. The IHS of claim 7, wherein the computing resource sharing controller engine is configured to:
provide the workload via the network to the computing resource provider system by providing the workload within a containerized workload environment that is included in the computing resource provider system and that utilizes the at least one computing resource.

14. A method for sharing computing resources, comprising:
receiving, by a computing resource sharing controller system from a computing resource provider system via the network, an identification of at least one computing resource included in the computing resource provider system for sharing, and computing resource sharing criteria defining how the at least one computing resource may be shared;
receiving, by the computing resource sharing controller system from a computing resource consumer system via the network and subsequent to receiving the identification of the at least one computing resource and the computing resource sharing criteria, a workload request associated with a workload;
determining, by the computing resource sharing controller system based on the computing resource sharing criteria, that the workload associated with the workload request may be provided by the at least one computing resource; and
providing, by the computing resource sharing controller system in response to determining that the workload may be provided by the at least one computing resource, the workload via the network to the computing resource provider system to cause the at least one computing resource to perform the workload.

15. The method of claim 14, further comprising:
performing, by the computing resource sharing controller system in response to receiving the workload request, a security analysis of the workload to determine that the workload is secure, wherein the workload is provided via the network to the computing resource provider system in response to determining that the workload is secure.

16. The method of claim 14, wherein the computing resource sharing criteria includes a computing resource sharing time period during which the at least one computing resource may be shared, and wherein the workload request includes a workload performance time period during which the workload should be performed and that falls within the computing resource sharing time period.

17. The method of claim 14, further comprising:
receiving, by a global controller subsystem included in the computing resource sharing controller system from the resource provider system via the network, the identification of at least one computing resource included in the computing resource provider system for sharing, and computing resource sharing criteria defining how the at least one computing resource may be shared and, in response, identify a regional controller sub-engine for controlling the at least one computing resource; and
receiving, by the global controller subsystem included in the computing resource sharing controller system from the resource consumer system via the network and subsequent to receiving the identification of the at least one computing resource and the computing resource sharing criteria, the workload request associated with the workload and, in response, identify the regional controller sub-engine for placing the workload; and
determining, by the regional controller subsystem included in the computing resource sharing controller system in response to being identified to control the at least one computing resource and place the workload by the global controller subsystem and based on the computing resource sharing criteria, that the workload associated with the workload request may be provided by at least one computing resource; and
providing, by the regional controller subsystem included in the computing resource sharing controller system in response to being identified to control the at least one computing resource and place the workload by the global controller subsystem and determining that the workload may be provided by at least one computing resource, the workload via the network to the computing resource provider system to cause the at least one computing resource to perform the workload.

18. The method of claim 14, further comprising:
configuring, by the computing resource sharing controller system in response to receiving the identification of at least one computing resource included in the computing resource provider system for sharing, the at least one computing resource to provide:
at least one worker subsystem that is configured to perform workloads; and
at least one proxy subsystem that is configured to transmit workload communications to and from the at least one worker subsystem.

19. The method of claim 14, further comprising:
registering, by the computing resource sharing controller system in response to determining that the workload may be provided by the at least one computing resource, a route to the at least one computing resource in a domain name system, wherein the route is configured for use by a user device to communicate with the workload performed by the at least one computing resource.

20. The method of claim 14, further comprising:
providing, by the computing resource sharing controller system, the workload via the network to the computing resource provider system by providing the workload within a containerized workload environment that is included in the computing resource provider system and that utilizes the at least one computing resource.
